(19) United States
(12) Patent Application Publication
(10) Pub. No.: US 2018/0220132 A1
(43) Pub. Date: Aug. 2, 2018

(54) ENCODER, DECODER, AND ENCODING/DECODING PROCESSING METHOD

(71) Applicant: FUJITSU LIMITED, Kawasaki-shi (JP)

(72) Inventors: Wataru KANEMORI, Fukuoka (JP); Naofumi KOMORI, Dazaifu (JP); Kusuo FUKUDA, Munakata (JP); Yoshikatsu KOHARA, Kitakyushu (JP); Takafumi KAMITO, Fukuoka (JP); Masaru NISHIDA, Fukuoka (JP); Etsuko YAMASHITA, Fukuoka (JP)

(73) Assignee: FUJITSU LIMITED, Kawasaki-shi (JP)

(21) Appl. No.: 15/873,653

(22) Filed: Jan. 17, 2018

(30) Foreign Application Priority Data
Jan. 31, 2017 (JP) 2017-016287

(51) Int. Cl. H04N 19/119; H04N 19/52; H04N 19/176; H04N 19/44

(52) U.S. Cl. CPC H04N 19/119; H04N 19/44; H04N 19/176; H04N 19/52

(57) ABSTRACT

An encoder includes a memory and a processor coupled to the memory and configured to: divide an image to be processed among sequentially input images into a plurality of small images; encode the plurality of small images; transmit each of the small images encoded by the encoding processing unit in correspondence with information indicating a position in the image to be processed; and change a division position of the image by the image dividing unit with respect to other image followed by the image to be processed according to processing information at the time of executing the encoding.

### CROSS-REFERENCE TO RELATED APPLICATION

This application is based upon and claims the benefit of priority of the prior Japanese Patent Application No. 2017-016287, filed on Jan. 31, 2017, the entire contents of which are incorporated herein by reference.

### FIELD

The embodiments discussed herein are related to an encoder, a decoder, and an encoding/decoding processing method.

### BACKGROUND

Recently, a full high definition (HD) video (1920×1080 pixels) has been widely used, and the use of high-resolution 4K (3840×2160 pixels) or 8 K (7680×4320 pixels) videos has also been expanded.

When encoding an image formed with a large number of pixels, there is an encoder that divides an image to be encoded into a plurality of small images and encodes each of the divided small images. Since the encoding process of each of the divided small images is independent from each other, the image quality of the boundaries between the small images that are originally continuous becomes discontinuous, and when the small images are decoded and combined, the image quality of the boundary of each small image is different from each other so that the boundary may be conspicuous.

The following technique has been known as a method of making the boundary of small images inconspicuous. A technique of overlapping adjacent small image encoding regions has been known. In addition, a technique of encoding small images in a direction away from the boundary of the divided small images has been known. A technique of controlling a code amount from the degree of deterioration near the boundary has been known. In addition, a system of dividing images and transmitting the divided images has been known.

Related techniques are disclosed in, for example, Japanese Laid-Open Patent Publication Nos. 08-046961, and 10-234043, Japanese National Publication of International Patent Application No. 2009-063554, and Japanese Laid-Open Patent Publication Nos. 2003-348597, 2001-285876, 2000-59779, and 2007-281716.

### SUMMARY

According to an aspect of the embodiments, provided is an encoder including a memory and a processor coupled to the memory and configured to: divide an image to be processed among sequentially input images into a plurality of small images; encode the plurality of small images; transmit each of the small images encoded by the encoding processing unit in correspondence with information indicating a position in the image to be processed; and change a division position of the image by the image dividing unit with respect to other image followed by the image to be processed according to processing information at the time of executing the encoding.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a functional block diagram of an encoding/decoding system according to an embodiment;

FIG. 2 is a first example of division of a screen;

FIG. 3 is a second example of division of the screen;

FIG. 4 is a third example of division of the screen;

FIG. 5 is a fourth example of division of the screen;

FIG. 6 is a functional block diagram of an encoding processing unit according to the embodiment;

FIG. 7 is a functional block diagram of a decoding processing unit according to the embodiment;

FIG. 8 is a flowchart illustrating an encoding process according to the embodiment;

FIG. 9 is a diagram illustrating an example of a macro block of an input image;

FIG. 10 is a flowchart of a calculation process of a division position based on a motion vector;

FIG. 11 is a diagram illustrating a dividing line, the macro block, and the motion vector;

FIG. 12 is a flowchart illustrating a calculation process of a division position based on a code amount;

FIG. 13 is a diagram illustrating the dividing line, the macro block, and the code amount;

FIG. 14 is a diagram for explaining a case where the current division position is made different from the previous division position;

FIG. 15 is a flowchart illustrating a decoding process according to the embodiment; and

FIG. 16 is a configuration diagram of an information processing apparatus (computer).

### DESCRIPTION OF EMBODIMENTS

In the related art, when the boundaries of small images are made inconspicuous, there is a problem in that the circuit scale increases because many circuits such as memories and control circuits are added to an encoder and a decoder. For example, in the related art, a circuit is added that controls a code amount by determining a memory holding the image information of the overlapping encoding region and the degree of deterioration near the boundary.

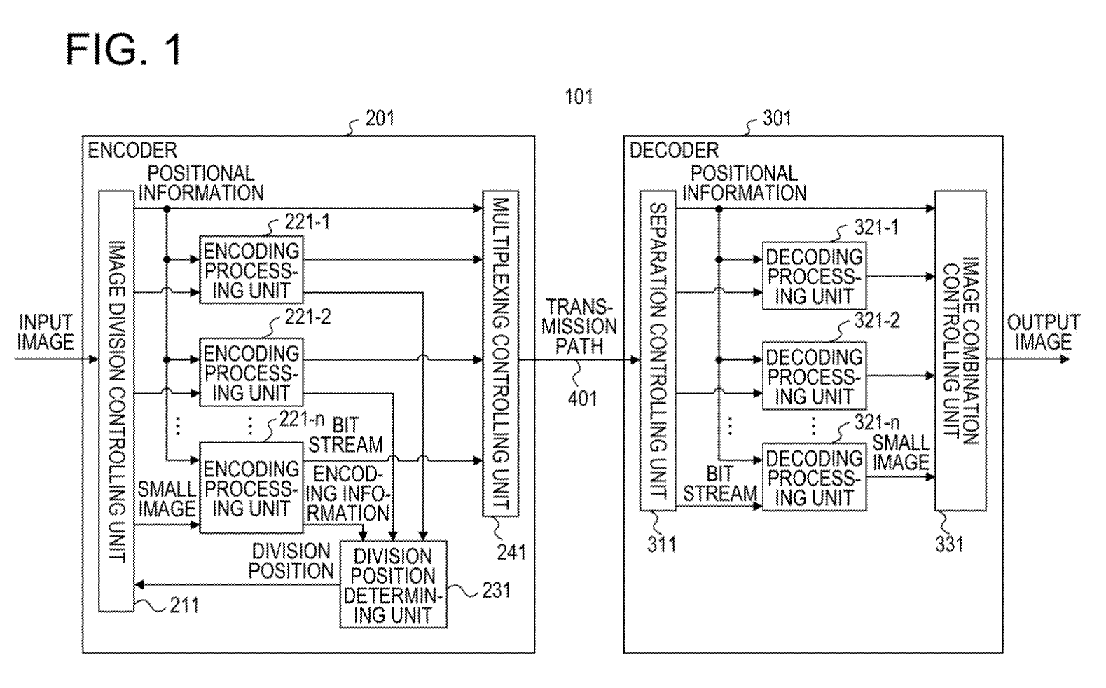

Hereinafter, an embodiment will be described with reference to the accompanying drawings. FIG. 1 is a functional block diagram of an encoding/decoding system according to the embodiment.

The encoding/decoding system 101 includes an encoder 201 and a decoder 301. The encoder 201 and the decoder 301 are connected by a transmission path 401.

The encoder 201 receives an image from an image input device such as a camera, encodes the received image (input image), and transmits the encoded input image to the decoder 301. The encoder 201 includes an image division controlling unit 211, an encoding processing unit 221-i (i=1 to n), a division position determining unit 231, and a multiplexing controlling unit 241.

The image division controlling unit 211 receives the input image, divides the input image at a division position input from the division position determining unit 231 to generate a plurality of small images, and outputs each of the plurality of small images and positional information indicating the position of the input image of each of the plurality of small images to the encoding processing unit 221-i. Further, the image division controlling unit 211 outputs the positional information of each of the plurality of small images to the multiplexing controlling unit 241. The positional information includes the coordinate of the upper left pixel of the small image and the number of pixels in the vertical and horizontal directions of the small image. The image division controlling unit 211 divides the input image at the division position calculated based on the information obtained in the encoding process of the other input image that is input before the input image. The image division controlling unit 211 is an example of an image dividing unit.

The encoding processing unit 221-i encodes the small image, outputs the bit stream (image data) of the encoded small image to the multiplexing controlling unit 241, and outputs the encoding information obtained by the encoding process to the division position determining unit 231. The encoding processing unit 221-i divides the small image into macro blocks each having a predetermined size (e.g., 16×16 pixels) to encode the small image in macro block units. The encoding information is a motion vector or code amount of each of a plurality of macro blocks included in the small image. The encoding information is an example of processing information. In addition, the number of the encoding processing units 221-i may be one, and in this case, the image division controlling unit 211 outputs a plurality of small images to one encoding processing unit 221-i in a time division manner. The encoding processing unit 221-i is an example of the encoding processing unit.

Based on the encoding information received from the encoding processing unit 221-i, the division position determining unit 231 calculates the division position of the image input next to the input image that has been encoded this time, and outputs the calculated division position to the image division controlling unit 211. Thus, the division position determining unit 231 changes the previously calculated division position to the division position calculated this time. The division position determining unit 231 is an example of the encoding position controlling unit.

The multiplexing controlling unit 241 multiplexes the image data of the plurality of encoded small images to generate multiplexed data, and adds (corresponds) the positional information indicating the position of each of the plurality of small images in the input image to the multiplexed data to transmit the added positional information to the decoder 301. The multiplexing controlling unit 241 is an example of the transmitting unit.

The decoder 301 includes a separation controlling unit 311, a decoding processing unit 321-i, and an image combination controlling unit 331.

The separation controlling unit 311 receives the multiplexed data and separates the multiplexed data into the image data of the plurality of encoded small images based on the positional information. The separation controlling unit 311 outputs each of the pieces of image data of the plurality of encoded small images and the positional information to the decoding processing unit 321-i. Further, the separation controlling unit 311 outputs the positional information to the image combination controlling unit 331. The separation controlling unit 311 is an example of the receiving unit and the dividing unit.

The decoding processing unit 321-i decodes the image data of the encoded small image and outputs the decoded small image to the image combination controlling unit 331.

The image combination controlling unit 331 combines a plurality of decoded small images based on the positional information, and generates an output image to output the output image. The image combination controlling unit 331 outputs the output image to, for example, a display device that displays the output image.

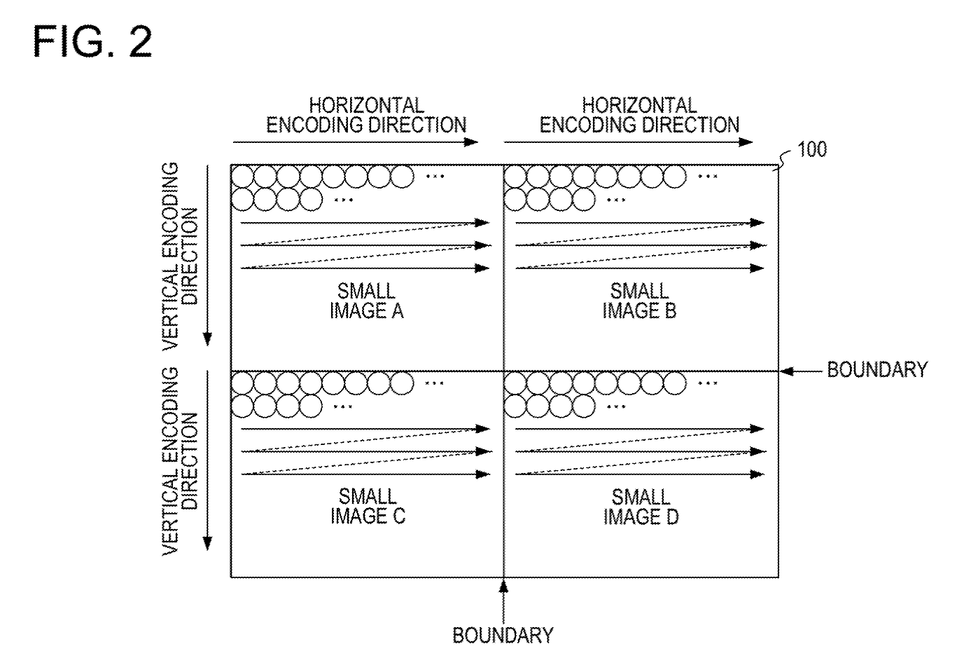

When the input image is divided into four portions, the image is divided as illustrated below. FIG. 2 is a first example of division of a screen.

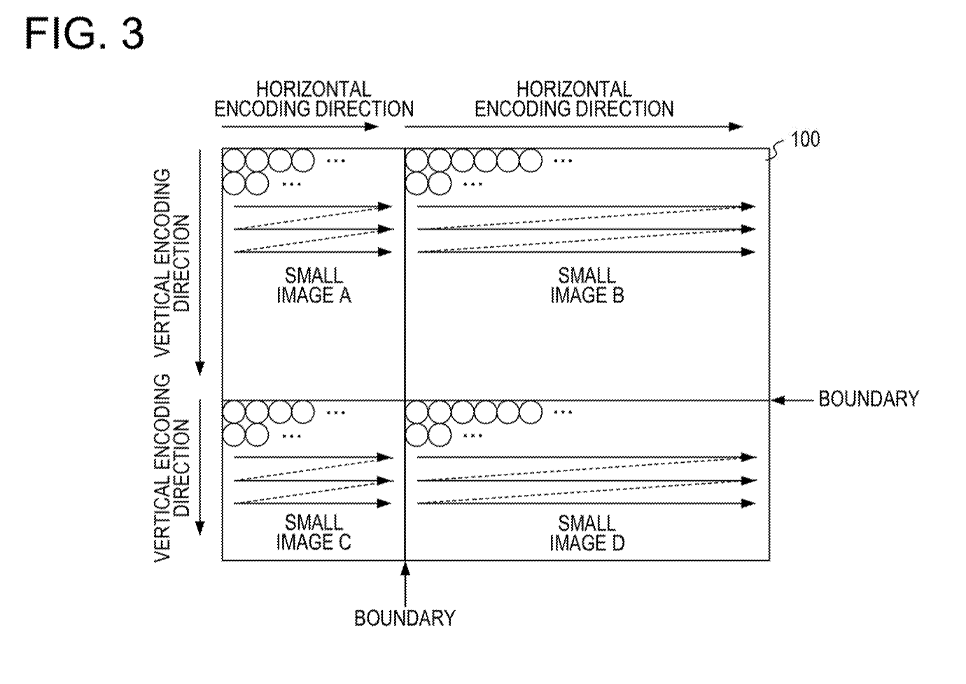

FIG. 3 is a second example of division of the screen. As illustrated in FIG. 2, the input image 100 is divided at the center of the horizontal and vertical directions, respectively, and the images at the upper left, upper right, lower left, and lower right are referred to as small images A to D, respectively. Further, as illustrated in FIG. 3, the input image 100 is divided at the position on the left side from the center in the horizontal direction and the position on the lower side from the center in the vertical direction, and the images at the upper left, upper right, lower left, and lower right are referred to as the small images A to D, respectively.

In the small images A to D, the encoding in the horizontal direction is performed from the left end to the right end of the top line of each small image, and when the right end of each small image is reached, the transition is first made to the line below the current line, and the encoding is performed again from the left end to the right end.

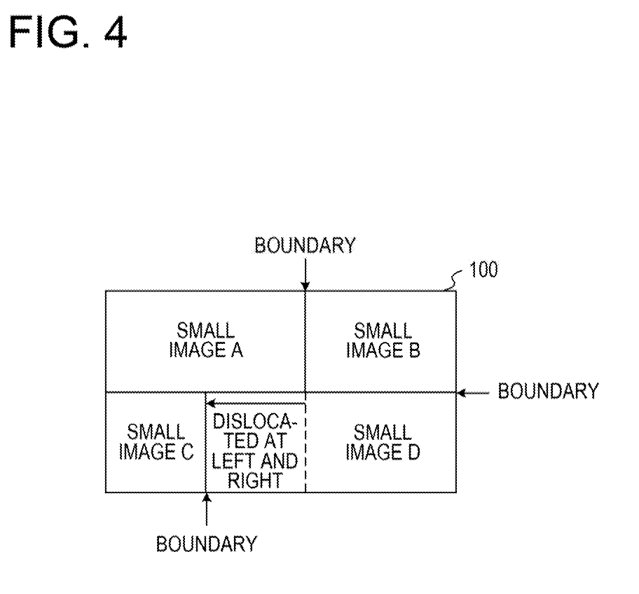

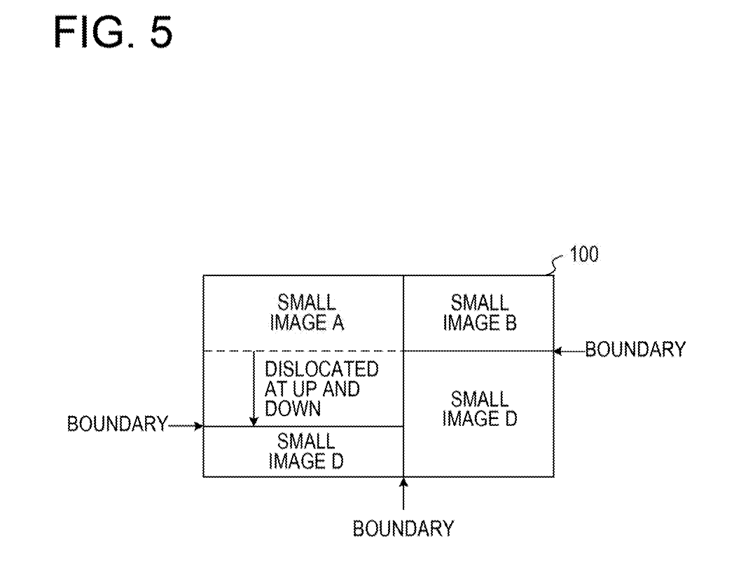

FIG. 4 is a third example of division of the screen. FIG. 5 is a fourth example of division of the screen.

As illustrated in FIG. 4, the input image 100 is divided into four portions. When the divided images at the upper left, upper right, lower left, and lower right are referred to as the small images A to D, respectively, the horizontal position of the boundary which divides the small image A and the small image B on the upper side of the input image 100 and the horizontal position of the boundary which divides the small image C and the small image D on the lower side of the input image 100 may be divided so as to be different from each other.

Further, as illustrated in FIG. 5, the input image 100 is divided into four portions. When the divided images at the upper left, upper right, lower left, and lower right are referred to as small images A to D, respectively, the vertical position of the boundary which divides the small image B and the small image D on the right side of the input image 100 and the vertical position of the boundary which divides small image A and small image C on the left side of the input image 100 may be divided so as to be different from each other.

The number of divided small images and the position of the boundary are merely examples, and may be divided into any number of small images, for example, four small images only in the horizontal boundary, four small images only in the vertical boundary, or nine or sixteen small images.

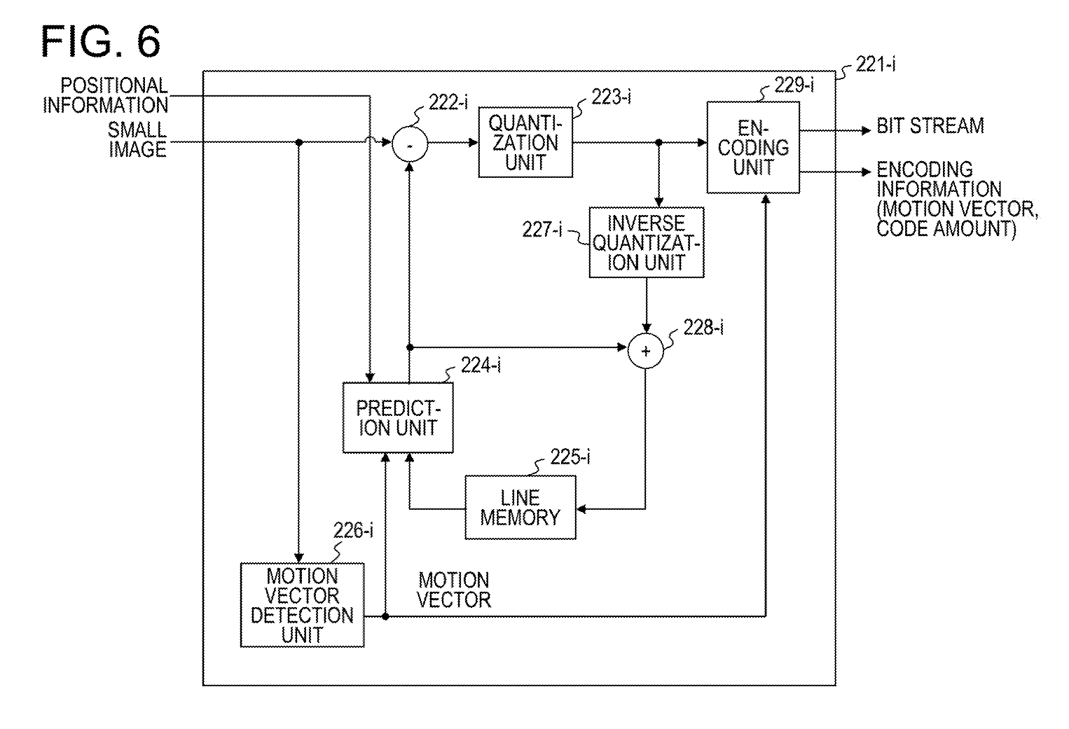

FIG. 6 is a functional block diagram of the encoding processing unit according to the embodiment. The encoding processing unit 221-i includes a subtraction unit 222-i, a quantization unit 223-i, a prediction unit 224-i, a line memory 225-i, a motion vector detection unit 226-i, an inverse quantization unit 227-i, an addition unit 228-i, and an encoding unit 229-i.

The subtraction unit 222-i calculates a prediction residual by subtracting a pixel value of each pixel of the prediction image from the pixel value of each pixel of the input small image.

The quantization unit 223-i applies orthogonal transformation to the prediction residual and applies quantization to the data converted into a spatial frequency domain to calculate data to be encoded.

The prediction unit 224-i generates a prediction image based on the local decode image stored in the line memory 225-i and the motion vector input from the motion vector detection unit 226-i.

The line memory 225-i stores the local decode image output from the addition unit 228-i.

The motion vector detection unit 226-i detects a motion vector for each local area (macro block (MB)) of the small image and outputs the motion vector of each of the detected macro blocks to the encoding unit 229-i.

The inverse quantization unit 227-i applies inverse quantization to the data quantized by the quantization unit 223-i, applies inverse orthogonal conversion to the inversely quantized data, and restores the prediction residual.

The addition unit 228-i generates the local decode image by adding the prediction image output from the prediction unit 224-i and the prediction residual output from the inverse quantization unit 227-i.

The encoding unit 229-i performs an entropy encoding process on the quantized data and outputs the encoded data (bit stream). Further, the encoding unit 229-i outputs the motion vector or the code amount as encoding information.

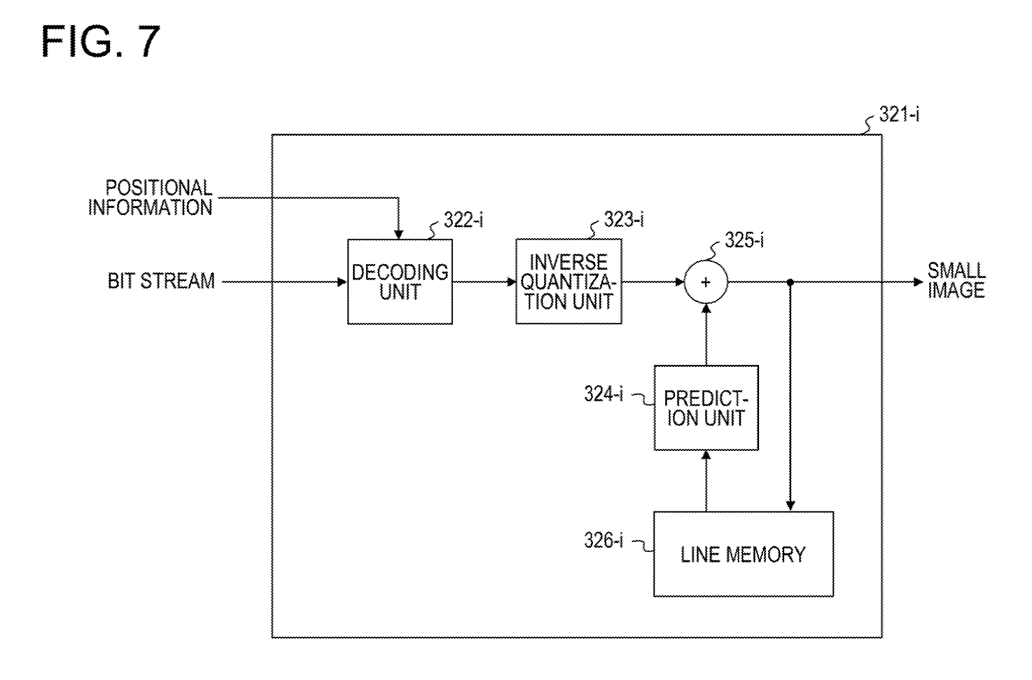

FIG. 7 is a functional block diagram of the decoding processing unit according to the embodiment. The decoding processing unit 321-i includes a decoding unit 322-i, an inverse quantization unit 323-i, a prediction unit 324-i, an addition unit 325-i, and a line memory 326-i.

The decoding unit 322-i decodes the bit stream based on the positional information and outputs the decoded data to the inverse quantization unit 323-i.

The inverse quantization unit 323-i applies inverse quantization to the decoded data, applies inverse orthogonal transformation to the inversely quantized data, restores the prediction residual, and outputs the restored prediction residual to the addition unit 325-i.

The prediction unit 324-i generates a prediction image from the decode image stored in the line memory 326-i and the prediction information of the bit stream to output the generated prediction image to the addition unit 325-i.

The addition unit 325-i adds the prediction image and the prediction residual to generate the small image (decode image).

The line memory 326-i stores the small image output from the addition unit 325-i.

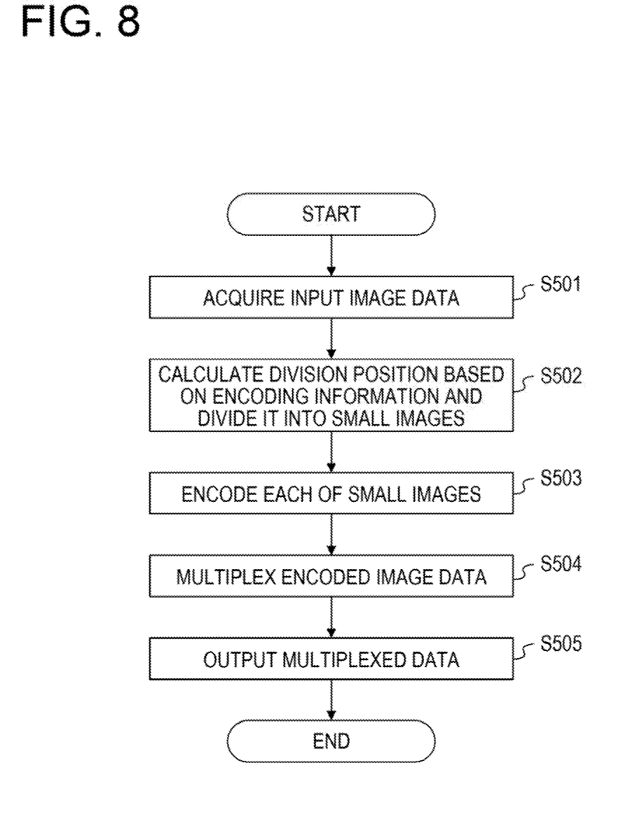

FIG. 8 is a flowchart of an encoding process according to the embodiment.

In step S501, the image division controlling unit 211 acquires an input image. In step S502, the division position determining unit 231 receives, from the encoding processing unit 221-i, the encoding information calculated in the encoding process of the input image immediately preceding the input image that has been acquired this time, calculates the division position based on the encoding information, and outputs the calculated division position to the image division controlling unit 211. The encoding information is, for example, a motion vector or a code amount. The image division controlling unit 211 receives the division position from the division position calculating unit 231, divides the input image based on the corresponding division position, and generates a plurality of small images. The division position calculating unit 231 outputs each of the plurality of small images to the encoding processing unit 221-i.

In step S503, the encoding processing unit 221-i encodes the input small image and outputs the encoded small image (bit stream) to the multiplexing controlling unit 241.

In step S504, the multiplexing controlling unit 241 generates multiplexed data (bit stream) by multiplexing a plurality of encoded small images received from the encoding processing unit 221-i, and adds the positional information indicating the positions of each of the plurality of small images in the input image to the multiplexed data.

In step S505, the multiplexing controlling unit 241 outputs the multiplexed data including the positional information and the plurality of encoded small images to the decoder 301.

Further, FIG. 8 illustrates an encoding process for one image. When images constituting a video are sequentially input into the encoder 201, the processes of steps S501 to S505 are repeatedly performed each time the image is input.

Next, the calculation process of the division position based on the encoding information of step S502 will be described in detail.

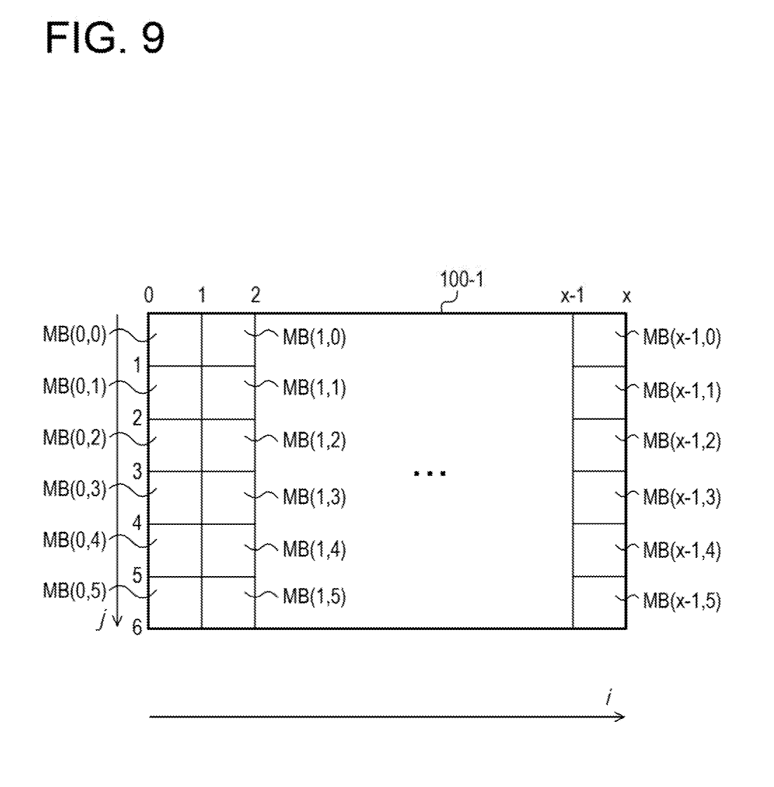

Hereinafter, a case where the division position is calculated based on an input image 100-1 as illustrated in FIG. 9 will be described. After the input image 100-1 is divided into a plurality of small images, each small image is encoded in a macro block unit having a predetermined size in the encoding processing unit 221-i. The input image 100-1 in FIG. 9 includes x number of horizontal macro blocks and y number of vertical (=6) macro blocks, and the macro block of the i-th from the left and of the j-th from the top of the input image 100-1 is denoted by macro block MB (i-1, j-i). The horizontal position coordinate i and the vertical position coordinate j used in the following description are the coordinates of the macro block unit. For example, when the size of the macro block is 16×16, the horizontal position coordinate i and the vertical position coordinate j are the coordinates of 16×i and 16×j in the pixel unit coordinates of the input image.

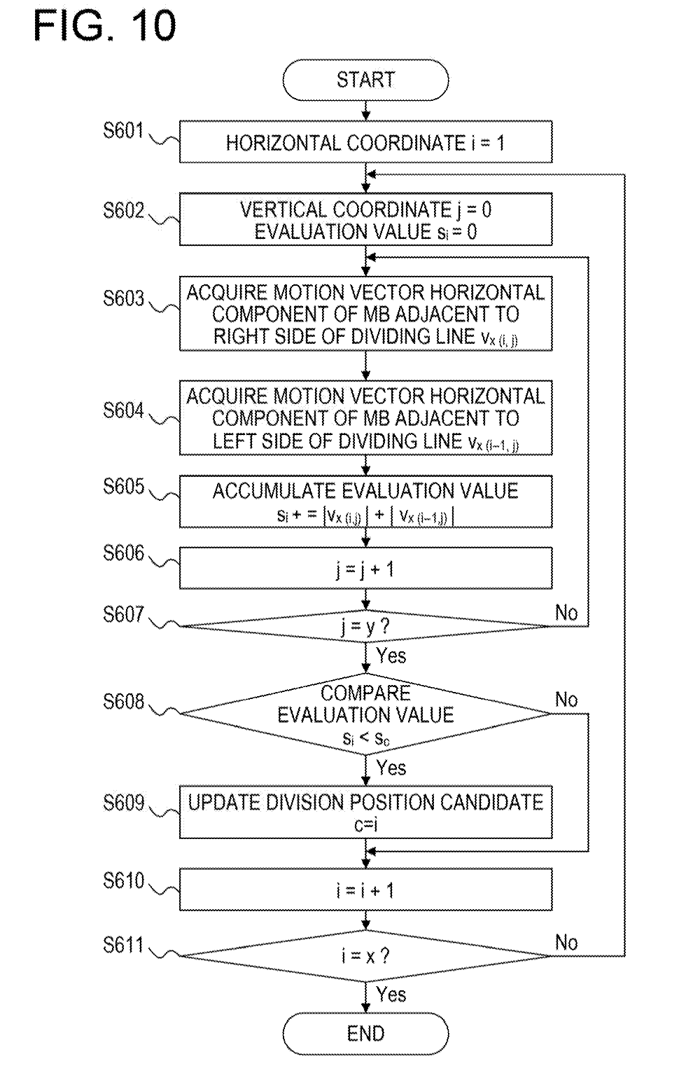

FIG. 10 is a flowchart of a calculation process of a division position based on the motion vector. In step S601, the division position determining unit 231 sets the horizontal position coordinate i as 1. The horizontal position coordinate i indicates the coordinate of the dividing line.

In step S602, the division position determining unit 231 sets the vertical position coordinate j as 0 and sets the evaluation value Si as 0.

In step S603, the division position determining unit 231 acquires the absolute value of a horizontal component Vx (i, j) of the motion vector V (i, j) of the macro block MB (i, j) adjacent to the right side of the dividing line.

In step S604, the division position determining unit 231 acquires the absolute value of the horizontal component Vx (i-1, j) of the motion vector V (i-1, j) of the macro block MB (i-1, j) adjacent to the left side of the dividing line.

In step S605, the division position determining unit 231 accumulates the absolute value of the horizontal component Vx (i, j) of the motion vector V (i, j) and the absolute value of the horizontal component Vx (i-1, j) of the motion vector V (i-1, j) to the evaluation value Si.

In step S606, the division position determining unit 231 adds the vertical position coordinate j by one. In step S607, the division position determining unit 231 determines whether the vertical position coordinate j and the number y of macro blocks in the vertical direction match each other. When the vertical position coordinate j and the number y (y=6 in the input image 100-1 of FIG. 9) of macro blocks in the vertical direction (i.e., the vertical position coordinate of the lower end of the input image) match each other, control proceeds to step S608, and when a match is not made, control returns to step S603.

In step S608, the division position determining unit 231 compares the evaluation value Si with the evaluation value Sc which is the smallest evaluation value calculated so far. When the evaluation value Si is smaller than the evaluation value Sc, control proceeds to step S609, and when the evaluation value Si is equal to or larger than the evaluation value Sc, control proceeds to step S610.

In step S609, the division position determining unit 231 updates the division position candidate c to the value of the horizontal position coordinate i. Further, the evaluation value Sc is updated to the value of the evaluation value Si.

In step S610, the division position determining unit 231 adds the horizontal position coordinate i by one. In step S611, the division position determining unit 231 determines whether the horizontal position coordinate i and the number x of macro blocks in the horizontal direction match each other. When the horizontal position coordinate i and the number x of macro blocks in the horizontal direction (i.e., the horizontal position coordinate of the right end of the input image) match each other, the division position determining unit 231 outputs the division position candidate c as a division position, and when a match is not made, control returns to step S602.

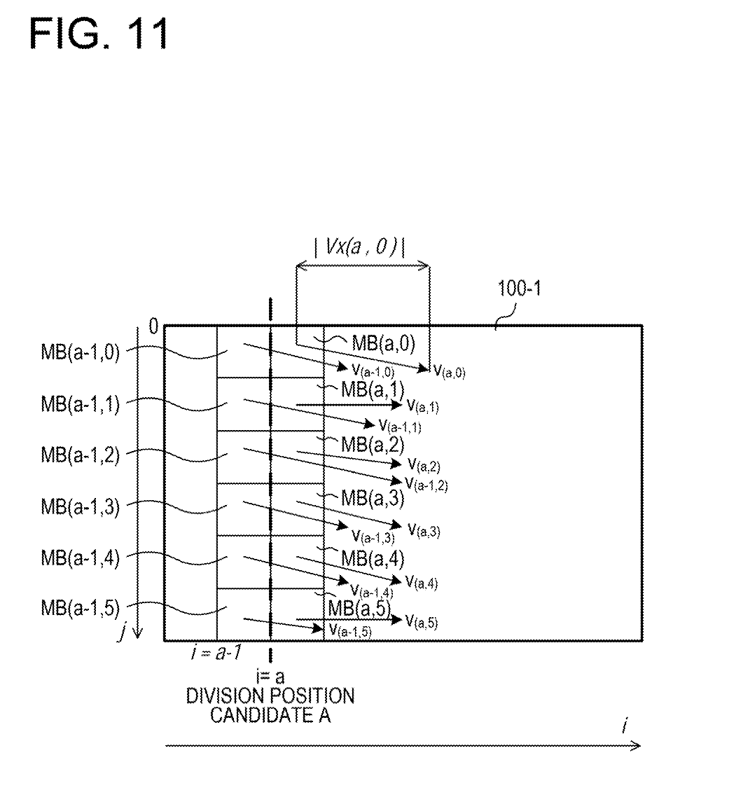

FIG. 11 is a diagram illustrating the dividing line, the macro block, and the motion vector. In the case of the horizontal position coordinate i=a, the evaluation value Sa is the sum of the absolute values |Vx (a, 0)| to |Vx (a, 5)| of the horizontal components of the motion vectors V (a, 0) to V (a, 5) of the macro blocks MB (a, 0) to MB (a, 5) adjacent to the right side of the dividing line of i=a, and the absolute values |Vx (a-1, 0)| to |Vx (a-1, 5)| of the horizontal components of the motion vectors V (a-1, 0) to V (a-1, 5) of the macro blocks MB (a-1, 0) to MB (a-1, 5) adjacent to the left side of the dividing line of i=a.

That is, the evaluation value Si in the horizontal position coordinate i is calculated in the following equation (1).

$${s}_{i} = {\sum }_{j = 0}^{y - 1} ( \vert {V}_{x ( i , j )} \vert + \vert {V}_{x ( i - 1 , j )} \vert ) \qquad ( 1 )$$

In the above-described calculation process of the division position in FIG. 10, the position in the horizontal direction of the dividing line in the vertical direction (division position), which divides the input image into left and right, is calculated. However, when calculating the position in the vertical direction of the dividing line in the horizontal direction (division position), which divides the input image into upper and lower portions, the calculation is performed as follows. The division position determining unit 231 calculates the sum of the vertical absolute values of the motion vectors of a plurality of macro blocks adjacent to each other above and below the dividing line candidates in the horizontal direction in all of the dividing line candidates in the horizontal direction, as the evaluation value of the corresponding dividing line candidate, and uses the position of the dividing line candidate corresponding to the smallest evaluation value among a plurality of evaluation values as the division position.

Further, in the above-described calculation process of the division position in FIG. 10, one of the plurality of division position candidates is calculated as a division position, but a plurality of division positions to be calculated may also be used. For example, an evaluation value of a predetermined number may be selected in ascending order of evaluation values of all calculated division position candidates, and a division position candidate corresponding to the evaluation value of the selected predetermined number may be output as a division position.

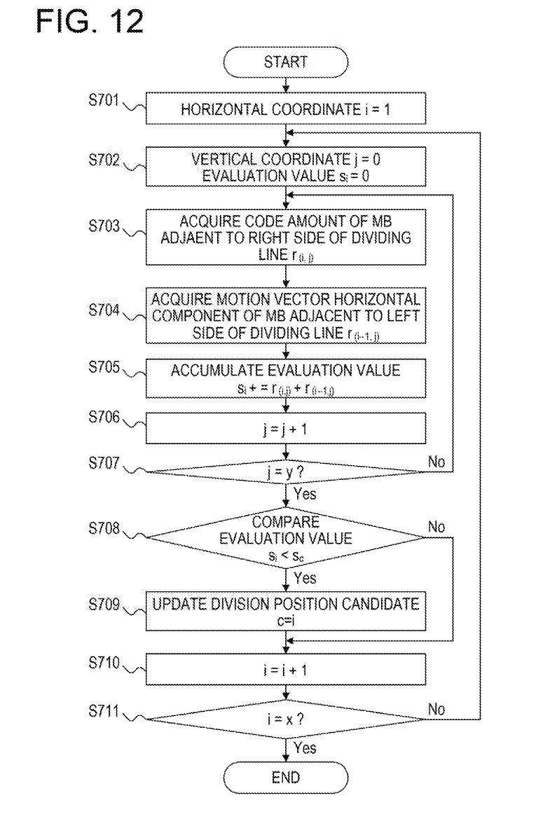

FIG. 12 is a flowchart of a calculation process of a division position based on a code amount. In step S701, the division position determining unit 231 sets the horizontal position coordinate i as 1. The horizontal position coordinate i indicates the coordinate of the dividing line. The horizontal position coordinate i is the coordinate of the macro block unit.

In step S702, the division position determining unit 231 sets the vertical position coordinate j as 0 and the evaluation value Si as 0. The vertical position coordinate j is the coordinate of the macro block unit.

In step S703, the division position determining unit 231 acquires the code amount r (i, j) of the macro block MB (i, j) adjacent to the right side of the dividing line.

In step S704, the division position determining unit 231 acquires the code amount r (i-1, j) of the macro block MB (i-1, j) adjacent to the left side of the dividing line.

In step S705, the division position determining unit 231 accumulates the code amount r (i, j) and the code amount r (i-1, j) to the evaluation value Si.

In step S706, the division position determining unit 231 adds the vertical position coordinate j by one. In step S706, the division position determining unit 231 determines whether the vertical position coordinate j and the number y of macro blocks in the vertical direction (i.e., the vertical coordinate of the lower end of the input image) match each other. When the vertical position coordinate j and the number y (y=6 in the input image 100-1 of FIG. 9) of macro blocks in the vertical direction match each other, control proceeds to step S708, and when a match is not made, control returns to step S703.

In step S708, the division position determining unit 231 compares the evaluation value S with the evaluation value Sc which is the smallest evaluation value calculated so far. When the evaluation value Si is smaller than the evaluation value Sc, control proceeds to step S709, and when the evaluation value Si is equal to or larger than the evaluation value Sc, control proceeds to step S710.

In step S709, the division position determining unit 231 updates the division position candidate c to the value of the horizontal position coordinate i. Further, the evaluation value Sc is updated to the value of the evaluation value Si. In step S710, the division position determining unit 231 adds the horizontal position coordinate i by one.

In step S711, the division position determining unit 231 determines whether the horizontal position coordinate i and the number x of macro blocks in the horizontal direction match each other. When the horizontal position coordinate i and the number x of macro blocks in the horizontal direction (i.e., the horizontal coordinate of the right end of the input image) match each other, the division position determining unit 231 outputs the division position candidate c as a division position, and when a match is not made, control returns to step S702.

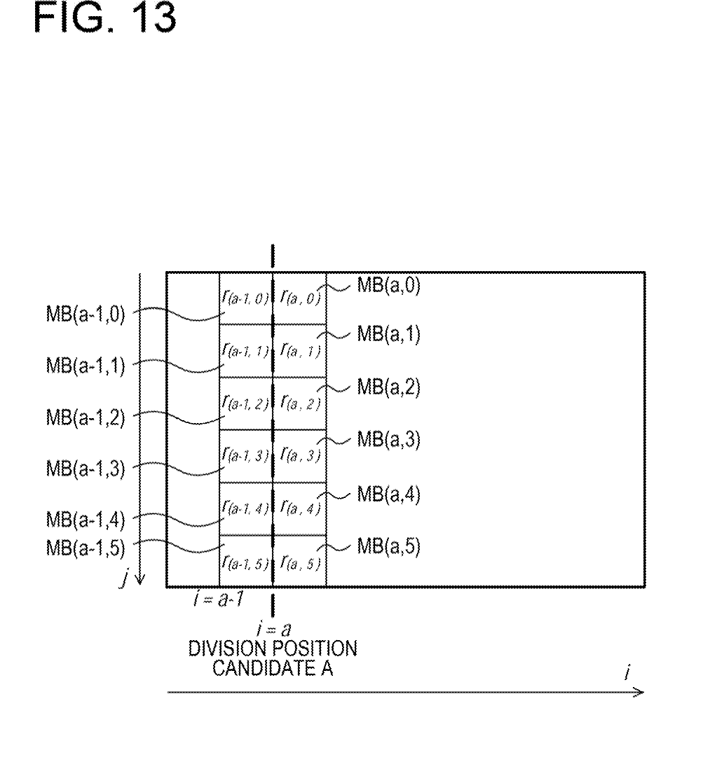

FIG. 13 is a diagram illustrating the dividing line, the macro block, and the code amount. In the case of the horizontal position coordinate i=a, the evaluation value Sa is the sum of the code amounts r (a, 0) to r (a, 5) of macro blocks MB (a, 0) to MB (a, 5) adjacent to the right side of the dividing line i=a, and the code amounts r (a-1, 0) to r (a-1, 5) of macro blocks MB (a-1, 0) to MB (a-1, 5) adjacent to the left side of the dividing line i=a.

That is, the evaluation value Si in the horizontal position coordinate i is calculated in the following equation (2).

$${s}_{i} = {\sum }_{j = 0}^{y - 1} ( {r}_{( i , j )} + {r}_{( i - 1 , j )} ) \qquad ( 2 )$$

In the above-described calculation process of the division position in FIG. 12, the position in the horizontal direction of the dividing line in the vertical direction (division position), which divides the input image to the left and right, is calculated. However, when calculating the position in the vertical direction of the dividing line in the horizontal direction (division position), which divides the input image into upper and lower portions, the calculation is performed as follows. The division position determining unit 231 calculates the sum of the code amounts of a plurality of macro blocks adjacent to each other above and below the dividing line candidates in the horizontal direction in all of the dividing line candidates in the horizontal direction, as the evaluation value of the corresponding dividing line candidate, and uses the position of the dividing line candidate corresponding to the smallest evaluation value among a plurality of evaluation values as the division position.

Further, in the above-described calculation process of the division position in FIG. 12, one of the plurality of division position candidates is calculated as a division position, but a plurality of division positions to be calculated may also be used. For example, an evaluation value of a predetermined number may be selected in an ascending order of evaluation values of all calculated division position candidates, and a division position candidate corresponding to the evaluation value of the selected predetermined number may be output as a division position.

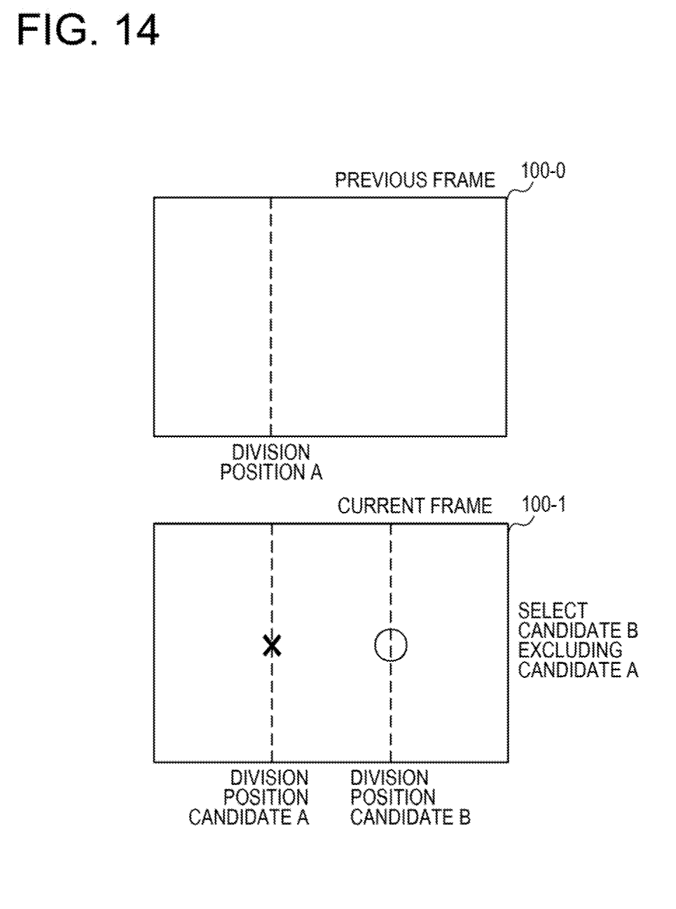

FIG. 14 is a diagram for explaining a case where the current division position is made different from the previous division position.

In the calculation process of the division position based on the motion vector and the calculation process of the division position based on the code amount as described above, the division position having the lowest evaluation value may be selected in each of the input images (all frames) and output to the image division controlling unit 211. However, depending on the picture of the input image, the same or neighboring division position may be continuously minimum.

In this case, since the boundary does not move between the frames and the deterioration of the boundary is conspicuous, the deterioration of the boundary may be avoided by selecting division position candidates having the lowest evaluation value among the plurality of division position candidates excluding the division position candidates which are near the division position of the nearest frame (i.e., a difference (distance) between the positions of the division position candidates and the division position of the nearest frame is less than a threshold value). That is, the division position determining unit 231 calculates the division position candidate having the lowest evaluation value as the division position of the image to be divided this time among the division position candidates that are separated from the division position of the nearest frame by a threshold value or more.

In FIG. 14, it is assumed that in the previously input image (frame) 100-0, the input image 100-0 is divided at division position A calculated based on the encoding information (motion vector or code amount) in the encoding process of the input image input before the previously input image. Further, it is assumed that in the calculation of the division position of the input image 100-1 at this time based on the encoding information in the encoding process of the previously input image 100-0, the evaluation value Sa at division position candidate A becomes the lowest, and the division position candidate A near the division position A is calculated as the division position candidate of the input image 100-1 at this time. When the division position candidate A is near the division position A of the previously input image 100-0, the division position determining unit 231 excludes the division position candidate A and selects division position candidate B at a position where the evaluation value is the second smallest and apart from the division position A as the division position.

In the calculation process of the division position by the motion vector and the calculation process of the division position based on the code amount as described above, division position candidates when dividing the input image by longitudinal or traverse lines are obtained. However, the input image illustrated in FIGS. 4 and 5 may be divided by non-longitudinal or non-traverse lines.

For example, when the input image is divided into four portions by non-longitudinal lines, the division position candidates which divide the input image vertically by traverse lines are first obtained based on a method of calculating the division position described in FIGS. 10 and 12, and the candidates at left and right division positions are evaluated by the calculation of division positions based on the motion vectors or the calculation of division positions based on the code amounts independently in each of the vertically divided image regions, so that the candidates at different left and right division positions in the vertically divided image regions are obtained.

Similarly, when the input image is divided into four portions by non-traverse lines, the division position candidates which divide the input image horizontally by longitudinal lines are first obtained based on a method of calculating the division position described in FIGS. 10 and 12, and the candidates at upper and lower division positions are obtained independently in each of the horizontally divided image regions. The spatial continuity of the division position is reduced by the fact that the division position is neither longitudinal nor traverse for the image, so that deterioration of the image quality at the division position may be made inconspicuous.

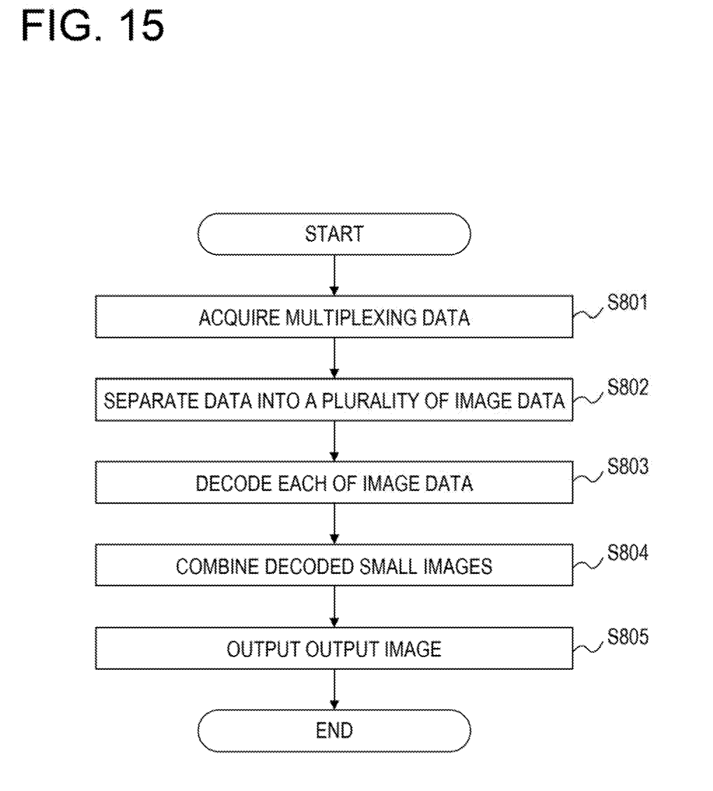

FIG. 15 is a flowchart of a decoding process according to the embodiment. In step S801, the separation controlling unit 311 receives multiplexed data from the encoder 201.

In step S802, the separation controlling unit 311 separates the multiplexed data into a plurality of pieces of image data based on the positional information included in the multiplexed data. Each of the plurality of pieces of image data is a bit stream of each of the plurality of encoded small images. The separation controlling unit 311 outputs each of the plurality of pieces of image data together with the positional information of the corresponding image data to the decoding processing unit 321-i. Further, the separation controlling unit 311 outputs the positional information to the image combination controlling unit 331.

In step S803, the decoding processing unit 321-i decodes the input image data to output the decoded small image to the image combination controlling unit 331.

In step S804, the image combination controlling unit 331 combines the plurality of decoded small images based on the positional information to generate the output image.

In step S805, the image combination controlling unit 331 outputs the output image. According to the encoding/decoding system according to the embodiment, the division position of the input image in the encoding process at this time may be set to a position different from the division position of the previously input image, so that the boundary is inconspicuous.

According to the encoding/decoding system according to the embodiment, the division position is calculated using the encoding information (motion vector or code amount) calculated in the ending process. Since the motion vector and the code amount are information that are calculated in the encoding process in the related art, an increase in the number of additional circuits may be suppressed as compared with the size of the additional circuits that is required when the boundary is not observed in the related art.

According to the encoding/decoding system of the embodiment, the picture of the input image is divided at the flat position and the boundary may not be conspicuous by dividing the input image at the position where the motion vector or code amount of the neighboring macro block is small. Further, in the embodiment, the division position is calculated based on the encoding information calculated in the encoding process of the input image immediately before the input image obtained this time, and the input image obtained this time is divided at the corresponding division position. However, since the input image obtained this time and the previously input image in the video are similar to each other, even when the input image obtained this time is divided at the division position calculated from the previously input image, there is a high possibility that the picture is divided at the flat position.

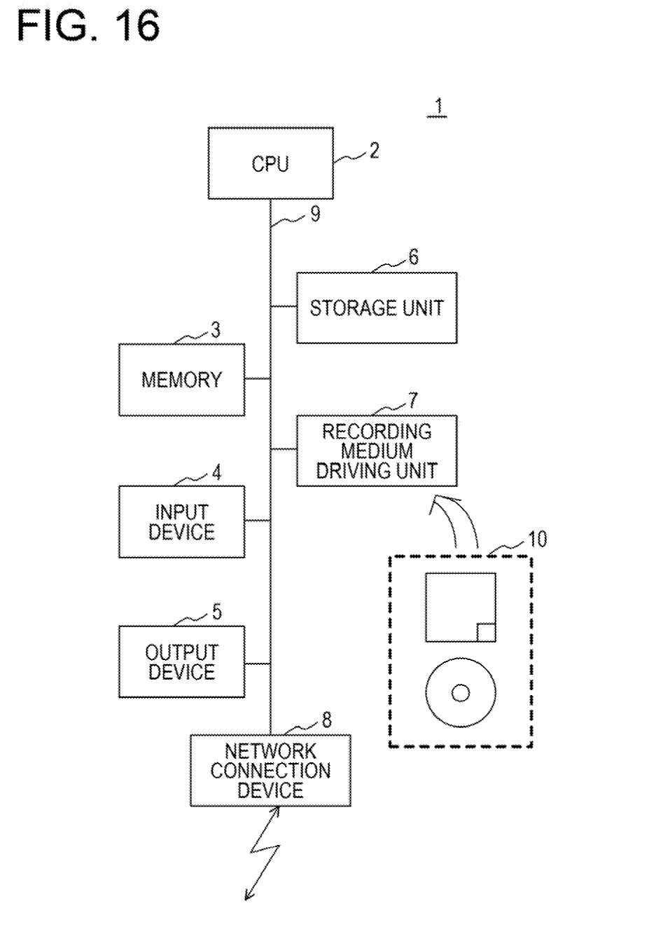

FIG. 16 is a configuration diagram of an information processing apparatus (computer). The encoder 201 and the decoder 301 according to the embodiment may be provided, for example, as a hardware circuit or using an information processing apparatus (computer) 1.

The information processing apparatus 1 includes a CPU 2, a memory 3, an input device 4, an output device 5, a storage unit 6, a recording medium driving unit 7, and a network connection device 8, which are connected with each other via a bus 9.

The CPU 2 is a central processing unit which controls the entirety of the information processing apparatus 1. The CPU 2 operates as the image division controlling unit 211, the encoding processing unit 221-i, the division position determining unit 231, the multiplexing controlling unit 241, the separation controlling unit 311, the decoding processing unit 321-i, and the image combination controlling unit 331.

The memory 3 is a memory such as a read only memory (ROM) or a random access memory (RAM) that temporarily stores a program or data stored in the storage unit 6 (or a portable recording medium 10) when the program is executed. The CPU 2 executes the above-described various processes by executing the program using the memory 3.

In this case, the program code itself read from the portable recording medium 10 or the like implements the function of the embodiment.

The input device 4 is used to input instructions or information from a user or an operator, to acquire data used in the information processing apparatus 1, and the like. The input device 4 is, for example, a keyboard, a mouse, a touch panel, a camera, a sensor, or the like.

The output device 5 is a device that outputs a query or processing result from the user or the operator, or operates by control by the CPU 2. The output device 5 is, for example, a display, a printer, or the like.

The storage unit 6 is, for example, a magnetic disk device, an optical disk device, a tape device, or the like. The information processing apparatus 1 stores the above-described program and data in the storage unit 6, and reads and uses the program and data in the memory 3 as necessary.

The recording medium driving unit 7 drives the portable recording medium 10 and accesses the recorded content. As for the portable recording medium, any computer-readable recording medium such as a memory card, a flexible disk, a compact disk read only memory (CD-ROM), an optical disk, or a magneto-optical disk is used. The user stores the above-described program and data in the portable recording medium 10, and reads and uses the program and data in the memory 3 as necessary.

The network connection device 8 is a communication interface that is connected to any communication network such as a local area network (LAN) or a wide area network (WAN), and performs data conversion in accordance with communication. The network connection device 8 transmits data by a device connected via a communication network and receives data from a device connected via the communication network.

In addition, the information processing apparatus 1 does not need to include all of components illustrated in FIG. 16, and some of the components may be omitted according to the applications or conditions.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An encoder, comprising:
a memory; and
a processor coupled to the memory and the processor configured to:
divide an image to be processed among sequentially input images into a plurality of small images;
encode the plurality of small images;
transmit each of the small images encoded by the encoding processing unit in correspondence with information indicating a position in the image to be processed; and
change a division position of the image by the image dividing unit with respect to other image followed by the image to be processed according to processing information at the time of executing the encoding.

2. The encoder according to claim 1, wherein the processing information is a motion vector calculated at the time of executing the encoding.

3. The encoder according to claim 1, wherein the processing information is a code amount of each of the encoded small images.

4. The encoder according to claim 1, wherein the encoding position controlling unit changes the division position of the other image to a position that is separated from the division position of the image to be processed by a threshold value or more.

5. A decoder, comprising:
a memory; and
a processor coupled to the memory and the processor configured to:
receive an encoded stream which divides an image to be processed among sequentially input images into a plurality of small images at a division position which is changed according to processing information at the time of executing encoding of other image preceding the image to be processed, and includes a plurality of pieces of encoded data of each of the plurality of small images generated by encoding the plurality of small images and positional information indicating positions of the plurality of small images in the image to be processed;
divide the encoded stream into the plurality of pieces of encoded data based on the positional information;
decode the plurality of pieces of encoded data to output a plurality of decoded small images; and
combine the plurality of decoded small images based on the positional information.

6. An encoding and decoding processing method, comprising:
dividing, by a first processor, an image to be processed among sequentially input images into a plurality of small images;
encoding the plurality of small images by the first processor;
transmitting, by the first processor, each of the small images obtained by the encoding process in correspondence with information indicating a position in the image to be processed;
changing, by the first processor, a division position of the image by the dividing process with respect to other image followed by the image to be processed according to processing information at the time of executing the encoding;
receiving, by a second processor, an encoded stream which includes a plurality of pieces of encoded data of each of the plurality of small images and positional information;
dividing, by the second processor, the encoded stream into the plurality of pieces of encoded data based on the positional information;
decoding, by the second processor, the plurality of pieces of encoded data to output the plurality of the decoded small images; and
combining, by the second processor, the plurality of the decoded small images based on the positional information.
